(19) United States
(12) Patent Application Publication
(10) Pub. No.: US 2018/0166068 A1
(43) Pub. Date: Jun. 14, 2018

(54) Cloud And Name Optimized Speech Recognition

(71) Applicant: Microsoft Technology Licensing, LLC, Redmond, WA (US)

(72) Inventors: Hans Peter Hess, Vancouver (CA); Oren Shir, Vancouver (CA); Naveen Kumar Verma, Vancouver (CA)

(21) Appl. No.: 15/419,483

(22) Filed: Jan. 30, 2017

Related U.S. Application Data
(60) Provisional application No. 62/432,648, filed on Dec. 11, 2016.

(51) Int. Cl. G10L 15/06; G10L 15/19; G10L 15/07; G10L 15/30

(52) U.S. Cl. CPC G10L 15/063; G10L 15/19; G10L 2015/0635; G10L 15/30; G10L 15/075

(57) ABSTRACT

A name file service is described that optimizes speech recognition in the cloud environment. The name file service monitors changes of users associated with tenant accounts and automatically updates a name file (or dictionary of names) for generating a grammar file used by speech recognition services. The described service may be used by auto-attendant applications as one example.

### CROSS-REFERENCE TO RELATED APPLICATION

This application claims the benefit of U.S. Provisional Patent Application Ser. No. 62/432,648, filed Dec. 11, 2016.

### BACKGROUND

Normally, in a dictation scenario, for example, where a person is speaking for purposes of transcribing their spoken word to text, a system can train on that person's voice to improve speech recognition of names and words. In an auto-attendant scenario, often anonymous people are saying a person's name which should be recognized as best as possible. There are hundreds of thousands of combinations of names and these can be very difficult to recognize in a speech recognition scenario. Accuracy of name recognition can be increased highly if it is possible to narrow down the potential inputs.

### BRIEF SUMMARY

Services for providing cloud and name optimized speech recognition are described. Through the described services, grammar files for multiple tenants can be generated and the tenants' directories monitored for changes so that updated grammar files can be automatically generated when there are changes to the tenants' directories. A name file service is provided that creates name files from tenants' directories, monitors for changes to the tenants' directories, and communicates with a grammar generation service to generate grammar files of the name files and automatically update the grammar files so that speech recognition of names can be optimally performed even when there are changes to users associated with a tenant account.

A name file service can receive requests to create anew name file for generating a grammar file. The name file service can provide an application programming interface (API) through which requests may be received. The request to create a new name file can include a tenant identifier that identifies a tenant account comprising a plurality of users associated therewith. In some cases, instead of a tenant identifier that identifies a tenant account, an identifier for an application and/or instance of a feature of that application may be used. Indeed, any identifier for indicating a source of names to populate a name file may be included. The name file service can, in response to receiving a request to create a new name file, create a new name file identifier for the new name file, populate the new name file with user names associated with the tenant account (or other source of the names), and send the new name file to a grammar generation service to generate the grammar file. The grammar file is then identified by the new name file identifier. The name file service stores the new name file identifier in a storage resource, the storage resource storing at least the new name file identifier. In addition to creating name files, the new name file service can monitor for changes to users that should be listed as part of the name file and can further automatically request that an updated grammar file be generated.

For example, once a new name file identifier is established for a tenant account, the name file service monitors for changes to users associated with the tenant account. Based on the monitored changes, the name file service can automatically update a grammar file for a tenant. That is, based on changes to the users associated with the tenant user account, the name file service can create an updated name file associated with the new name file identifier and send the updated name file to the grammar generation service to generate an updated grammar file, the new name file identifier now referencing the updated grammar file.

This Summary is provided to introduce a selection of concepts in a simplified form that are further described below in the Detailed Description. This Summary is not intended to identify key features or essential features of the claimed subject matter, nor is it intended to limit the scope of the claimed subject matter.

### BRIEF DESCRIPTION OF THE DRAWINGS

FIGS. 1A-1C illustrate an example operating environment for cloud and name optimized speech recognition.

FIGS. 2A-2C illustrate example processes carried out by a name file service for optimizing name recognition for multi-tenant systems.

FIG. 3A illustrates an example operating environment in which an implementation of techniques for optimizing name recognition in multi-tenant systems may be practiced.

FIG. 3B illustrates a diagram with example process flows that may be implemented by the operating environment of FIG. 3A.

FIG. 4 illustrates a block diagram of one example of a cloud-based multi-tenant service architecture.

FIG. 5 is a block diagram illustrating different levels of multi-tenancy in one example of a multi-tenant cloud architecture.

FIG. 6 illustrates components of a computing system that may be used to implement certain methods and services described herein.

### DETAILED DESCRIPTION

Name file services providing cloud and name optimized speech recognition are described. Through the described name file services, grammar files can be generated and, in some cases, directories can be monitored for changes so that updated grammar files can be automatically generated when there are changes to the directories.

The name file service can receive requests to create name files. Upon receiving a request to create a name file, the name file service can access, or is provided with, at least a set of names to populate a new name file. The name file service then provides the name file to a service that generates grammar files that can be used for speech recognition. The request to create a new name file can include a tenant identifier that identifies a tenant account comprising a plurality of users associated therewith. In some cases, instead of a tenant identifier that identifies a tenant account, an identifier for an application and/or instance of a feature of that application may be used. Indeed, any identifier for indicating a source of names to populate a name file may be included.

Accordingly, when tenant identifiers are provided, the name file service creates name files from the tenants' directories (e.g., from information about users associated with a tenant account). The name file service can be given access to the tenants' directories in order to obtain the information about the users. Similarly, in a case where an application identifier is provided, the name file service can communicate with a resource associated with the application to obtain information about the users. Further, when an identifier of an instance of a feature of an application (e.g., a conference call identifier), the identifier can be used to fetch the users associated with that instance.

In addition to creating name files, the new name file service can monitor for changes to users that should be listed as part of the name file and can further automatically request that an updated grammar file be generated. For example, the name file service can monitor changes to the tenants' directories and communicate with a grammar generation service to generate grammar files of the name files and automatically update the grammar files so that speech recognition of names can be optimally performed even when there are changes to users associated with a tenant account. Name files can be scoped in a variety of ways including, but not limited to, a specific tenant (e.g., tenant “Contoso”) and, optionally, a subset of users of that tenant (e.g., Contoso users located in Vancouver).

Unlike a single tenant system (an architecture in which a single instance of a software application and supporting infrastructure serves one customer), the described name file service enables the generation, monitoring, and updating of large amounts of grammar files for multi-tenant systems. In a single tenant system, an enterprise using a speech recognition service in conjunction with, for example, an auto attendant may download and run the service on their own system. In such a case, the processes for generating grammar files are managed for only a single enterprise. Any changes to a grammar file in a single tenant system can be easily dealt with by the administrator based on changes that the administrator is aware of.

However, in the multi-tenant system scenario, there is often a large amount of data. In some cases, there can be thousands of tenants and the tenants can have tens to hundreds of grammar files that should cover hundreds to thousands (to hundreds of thousands) of users. The multi-tenant service system handling this data is generally cloud-based. The tenant information is dynamic and therefore, it is important to keep all the grammar files updated. The described name file service filters and digests the large amount of data into a manageable size. In various embodiments, the described name file service enables the chunking, creating, storing (in the cloud), monitoring and processing of user names for use in increasing speech processing accuracy.

Speech processing accuracy can be improved because speech recognition, particularly of names, can be based on a current list of users associated with a tenant, application, or other source. In the auto-attendant scenario, if a caller (who may or may not be anonymous) wants to be transferred to someone at a company, then it can be expected that the desired someone is a person that is working at that company. The name file service has access to a list of the names of the people working in that specific company and can monitor for changes at that company. By continuing to monitor for changes and updating a list of the names of the people, a dictionary, or name file, for a grammar file can be kept current for that company (and similarly for all others that are tenants of cloud-based multi-tenant services). Thus, a grammar file for that company can be made current so that the name spoken by the caller can be identified by a speech recognition service used by the auto-attendant in a much higher quality (e.g., faster, more accurate) than a generic speech recognition (without a grammar file).

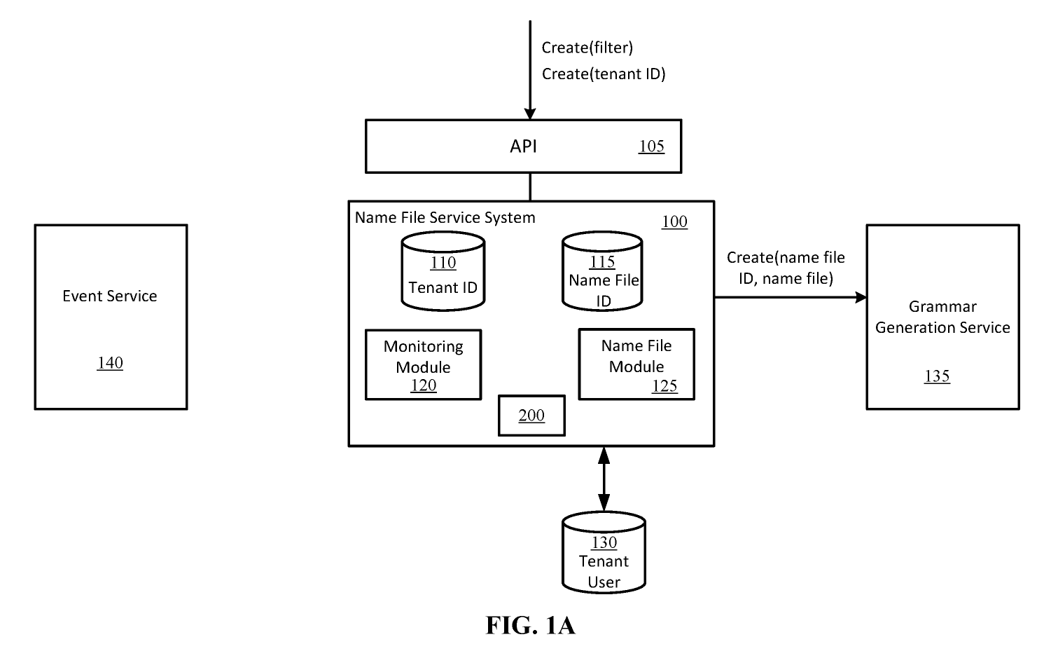

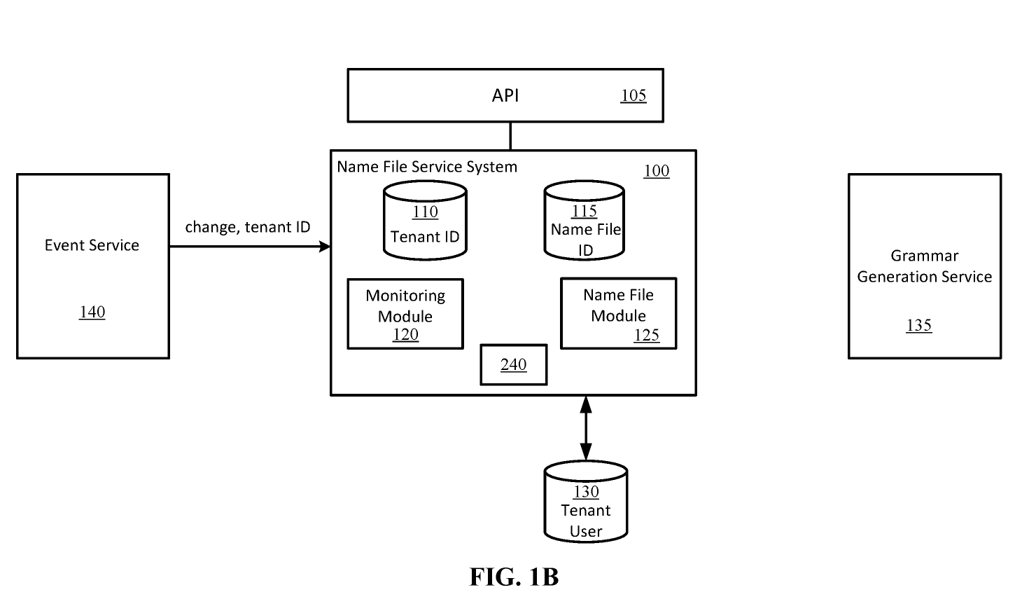

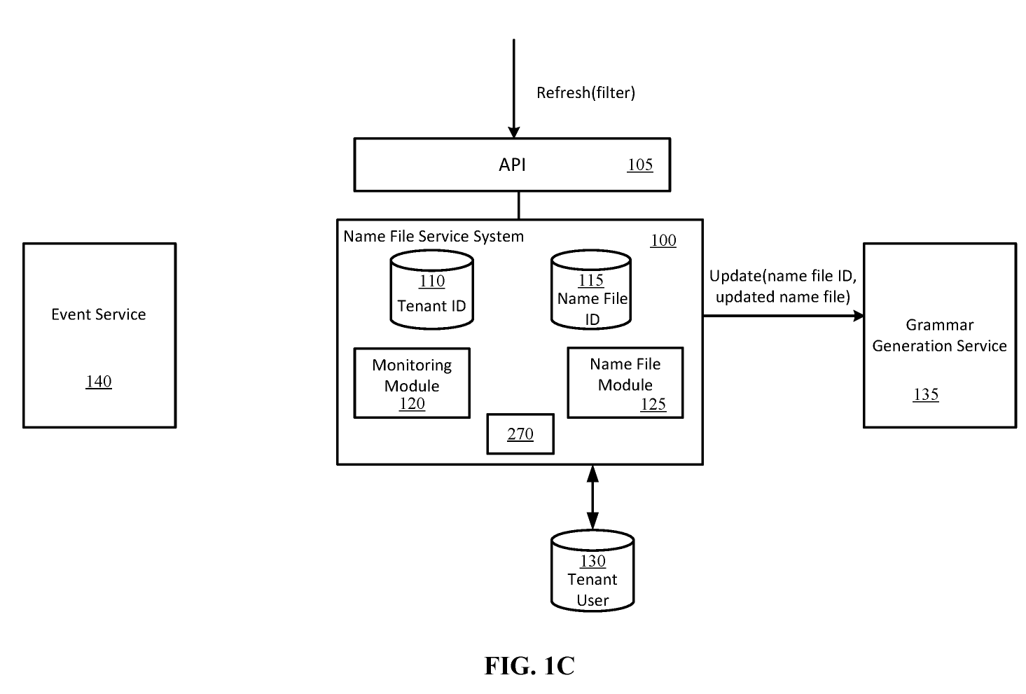

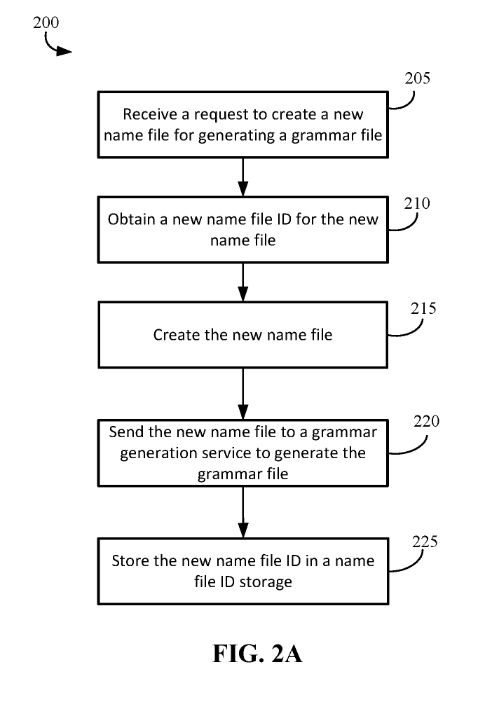

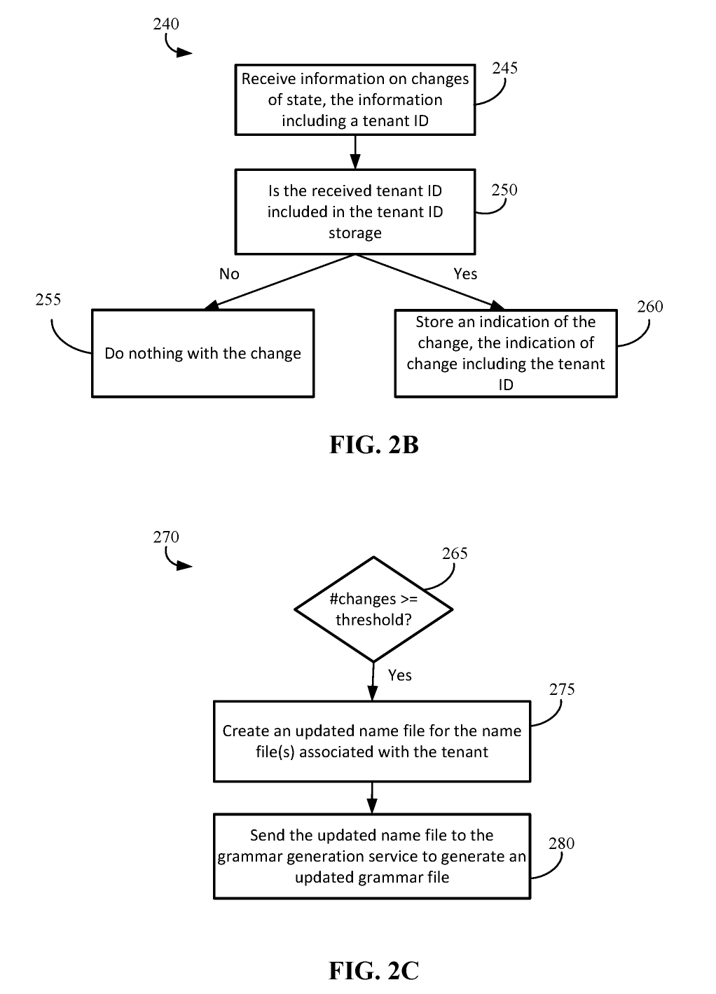

FIGS. 1A-1C illustrate an example operating environment for cloud and name optimized speech recognition; and FIGS. 2A-2C illustrate example processes carried out by a name file service for optimizing name recognition for multi-tenant systems. The terms “identifier” and “ID” may be used interchangeably herein.

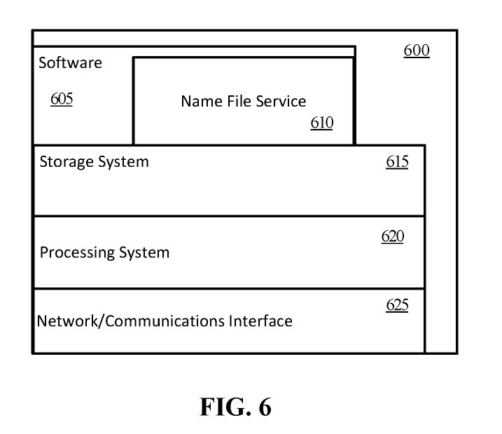

Referring to FIGS. 1A-1C, an operating environment for cloud and name optimized speech recognition can include name file service system 100 with application programming interface (API) 105. System 100 may be embodied such as described with respect to computing system 600 as shown in FIG. 6. System 100 can include one or more storage resources with structured data identifying tenant accounts that may be monitored by the name file service (e.g., Tenant ID storage 110) and name file IDs of name files for grammar files created at the request of the name file service (e.g., Name File ID storage 115).

The tenant ID storage 110 may contain information on provisioned tenants (e.g., those tenants that are registered for or otherwise authorized for the name file services and/or related services such as an auto-attendant). Each tenant may have a unique identifier associated therewith (a “tenant ID”). The system 100 can keep track of the provisioned tenants using, for example the tenant IDs themselves and/or other attributes such as the name of the tenant, a code, a flag, or anything that indicates that the tenant is registered with the name file service.

The name file ID storage 115 includes information on the name files maintained by system 100. A unique name file ID can be generated for each new name file created and is associated with a grammar file. The name file ID storage 115 can store name file IDs and associated attributes, including, but not limited to, a tenant ID (or other identifier indicating source of the user list) associated with the name file and any other filters (described in more detail later) used to adjust the scope of the name file. In addition, the name file ID storage 115 may store a grammar file ID of the grammar file created based on the name file identified by the name file ID. Although the tenant ID storage 110 and the name file ID storage 115 are shown in FIGS. 1A-1C as two separate storage resources, in some implementations, the tenant ID storage 110 and the name file ID storage 115 may be stored at a single storage resource or even stored across multiple resources.

System 100 may include hardware and/or software functionality for monitoring for changes to a tenant's directory (monitoring module 120) and creating a new or updated name file (name file module 125) and can perform one or more of processes 200, 240, and 270 of a name file service described with respect to FIGS. 2A-2C.

The operating environment can further include one or more services such as event service 140 and grammar generation service 135 with which the name file service (and system 100) communicate. The grammar generation service 135 can communicate with or be integrated with a speech recognition service. The name file service and the grammar generation service 135 may be separate services operated by separate entities or by a same entity. Alternatively, the name file service may be incorporated in the grammar generation service 135 (and may even be incorporated in a speech recognition service).

Also, included in the example operating environment is tenant user storage resource 130. The tenant user storage resource 130 may include structured data providing information on the names of users associated with a tenant (e.g., the tenant's directory) or application. In one example, the tenant user storage resource 130 may be in the form of an Active Directory directory service (available from Microsoft). In some cases, the tenant user storage resource 130 may be part of the system 100. However, in the example provided herein, the tenant user storage resource 130 is provided (and managed) by another service, but the system 100 may have access to the stored information. It should be understood, access to the information in the tenant user storage resource 130 is limited to that approved and authorized by the tenants.

Components (computing systems, storage resources, and the like) in the operating environment may operate on or in communication with each other over a network (not shown). The network can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

Communication to and from system 100 may be carried out, in some cases, via application programming interfaces (APIs), such as API 105. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Referring to FIG. 1A and FIG. 2A, a name file service, such as implemented by system 100, and performing process 200, can receive, via the API 105, a request to create a name file for generating a grammar file (205). The request may include a filter. The filter can include a tenant ID or other identifier of a source of user information, for example, of an application requesting the services of the name file service and/or an identifier of an instance of a feature of an application (e.g., an instance of an online conference). The filter can be used to indicate the names to be incorporated into the name file. Thus, a request to create a new name file can include one or more filter parameters for identifying the user names associated with the request.

The filter may include one or more parameters, for example, any user properties such as a name (or names) of a user, a department in which the user works, roles, group, a geographical region of the office of the user, and the like. The filters may even indicate specific users. The filter allows for the option to narrow down the names of the users in the name file. The filter may be a scoping feature that can allow the service to create name files that are scoped, for example, not only to a specific tenant, but a subset of users of that tenant.

As an illustrative example, a company may have 10,000 employees, but may only want to include the 500 employees in the sales department in the name file. In another example, a name file may be created for only the employees who work in the human resources department of the tenant or only the employees that work in the North American offices of the tenant.

The request to create the name file may be sent via a settings or initialization interface to, for example, an auto-attendant service. In some cases, the request to create the name file may be sent by other systems, applications, or services that utilize grammar files and speech recognition. The name file service may be used by anyone (or application) that is interested in synchronizing the current names associated with a tenant for speech recognition purposes. For example, the administrator of the tenant may be interested in synchronizing the current names associated with the tenant for speech recognition purposes, for example, for use with an auto-attendant service. In another example, an auto-attendant service or a service for a meeting application may register with the name file service.

The process of creating a new name file may be performed by the name file module 125 within the system 100. Upon receiving the request to create the new name file (205), a new name file ID for a new name file can be obtained (210); and a new name file can be created (215). The system 100 may create the new name (215) file by accessing (or requesting information from) the tenant user storage resource 130 (or other resource with user names) to populate the new name file with names of users associated with the received filter. For example, if the request to create a name file included “Contoso” as the tenant ID and “Human Resource Department” and “North America” as the additional filters, the system 100 would populate the name file with names of any employees from the company, Contoso, who are members of the Human Resource Department and work in any of Contoso's North American offices. The name file module 125 may communicate with the tenant user storage resource 130 to obtain the appropriate names that satisfy the filter. In some scenarios, the name file service will receive the names (and other relevant information) directly from source of the request (and possibly as part of the request).

The new name file can be populated with names as well as other information associated with the named users so that those terms can be used as part of the grammar file for speech recognition. In one example, the name file is populated with fields such as first name and last name. Other fields may be included such as, but not limited to, display name, middle name, phonetic name, department, and city.

Once the new name file is created (215), the system 100 can send the new name file, along with the new name file ID to the grammar generation service 135 to generate a grammar file (220). In some cases, the communication with the grammar generation service 135 may be through an API. The grammar generation service 135 can use the new name file to create a grammar file that can be associated with the name file ID. In some cases, the grammar generation service 135 can provide the name file service with the grammar file ID that identifies the grammar file to the grammar generation service (and speech recognition service).

The system 100 can store the new name file ID in the name file ID storage 115 (225). The new name file ID can be stored along with any filters associated with the new name file. In addition, a grammar file ID may be stored associated with the new name file ID. The name file ID may be different from the grammar file ID. For example, it may be possible to optimize if it is discovered that two name files end up with the same list of users so a single grammar file would be created. In some cases, the name file itself can be stored in the name file ID storage 115 or other storage resource of the system 100. System 100 may store the filter(s) or may store identifiers allowing the system 100 to access a filter stored somewhere else.

In some cases, creating the name file may include provisioning the tenant for the monitoring aspect of the name file service. In some of such cases, each time a request for a new name file is received, the monitoring aspect of the name file services may be provisioned. In other cases, the provisioning (e.g., registering) a tenant as one that is monitored may be a separate process from the creation of the name file. For example, an auto attendant service may communicate with the name file service a list of tenants that have been provisioned the appropriate services.

As an illustrative example, the tenants may be tenants of a collaboration service such as Skype for Business. A subset of the tenants of the collaboration service may have obtained a license for an auto-attendant feature. Setting up a name speech recognition feature for the auto-attendant feature can initiate communication between the auto-attendant feature (software) and the name file service so that the name file service creates a grammar for the desired configuration(s). Provisioning the tenant may include storing the tenant ID in the tenant ID storage 110. Once a tenant is provisioned, the name file service is aware that the tenant it to be monitored for changes.

In addition to providing an API for creating name files, the system 100 can allow for deleting name files and refreshing name files. In the case of deleting name files, the system 100 can receive, through the API 105, a request to delete a name file. The request may include a tenant ID and, in some cases, any other filter the name file may have. In response to receiving the request to delete a name file, the system 100 can send an indication to the grammar generation service 135 to delete a particular grammar file. The indication may include the name file ID or grammar file ID associated with the tenant ID (received as part of the request). In some cases where the request includes the tenant ID, the request may be to delete all grammar files associated with the tenant ID. In some cases, the request may be to delete a specific grammar file associated with the name file ID associated with the tenant ID and other filter.

In addition to sending the indication to delete the file the grammar generation service 135, the system 100 can remove the name file ID from the name file ID storage 115 and stop monitoring for changes. Refreshing name files will be described in more detail with respect to FIG. 1C.

Referring to FIGS. 1B and 2B, a name file service, such as implemented by system 100, and performing process 240, can monitor for changes to a tenant's directory through the monitoring module 120. The monitoring module 120 can monitor for changes to a tenant's directory including, but not limited to, when a user is added or removed, when a name of a user is modified (e.g., due to a name change), when a user's position or role in an enterprise has changed (e.g., role and/or position with respect to hierarchy or employment position), when a user has changed locations, when there is a change to the user's group membership and the like. Indeed, the changes that can be monitored may be to any property of a user associated with the tenant.

Monitoring for changes may include receiving information on changes of state (245). The information on changes may be received from a separate service, such as event service 140. The name file service may register to receive the event updates from event service 140 and use the event updates to monitor for changes to those tenants registered for the name file service. The monitoring module 120 may use the information stored in the tenant ID storage 110 to identify, from the received information on changes of state of tenants, those changes that belong to the tenant accounts associated with the tenant IDs stored as part of tenant ID storage 110. For example, as information on changes of state is received (245), the system 100 can compare the received tenant ID against the plurality of tenant IDs stored in the tenant ID storage 110 (250).

If the tenant ID is not included in the tenant ID storage 110, then the system 100 does nothing with the changes (255) and the received information is discarded. However, if the tenant ID is included in the tenant ID storage 110, then the monitoring module 120 may store an indication of the change (260). For example, the monitoring module can update a tenant entry to indicate that there are changes to users associated with the tenant account. In some cases, the monitoring for changes functionality block 120 may store the specific change received in a storage resource, such as a changed tenants storage resource (not shown). In other cases, the monitoring for changes functionality block 120 may store an indication that there was a change, such as a flag indicating an event change.

In further embodiments, the name file service directly accesses a tenant user resource 130 to identify changes (actively or passively). For example, the name file service may search the tenant user resource 130 for changes instead of or in addition to receiving event information from an event service 140.

As mentioned above, sources of user lists to be monitored may be based on an application and/or instance of a feature of an application. Such user lists may be monitored in a similar way as tenant directories based on the access provided by the application. However, instead of changes to users associated with a particular tenant, the system monitors for changes to users associated with a particular application and/or instance of a feature of the application (e.g., attendees of a web conference).

Referring to FIGS. 1C and 2C, a name file service, such as implemented by system 100, can perform process 270 to update a name file to be sent to the grammar generation service 135. The updating of the name file can be done automatically, based on the changes to the users associated with the tenant user account (identified because of the monitoring of changes).

In one example, the system 100 can, in response to a stored amount of indications of change for a tenant reaching a threshold amount (e.g., number of changes being equal to or greater than threshold (265)), create an updated name file for the name file(s) associated with the tenant (275). The system 100 can update all the name files associated with that tenant. For example, the system 100 may determine whether the tenant ID of the changed tenant is found in the tenant IDs stored associated with name file IDs in the name file ID storage 115. Any name files that have the same tenant ID can then be updated. The updated name files may be created by accessing the tenant user storage resource 130 to populate the updated name file with names of users for the tenant associated with the tenant ID. Once the updated name files have been created (275), the system 100 may send the updated name file(s) along with the associated name file indicator(s) (including the updated new name file and new name file indicator) to the grammar generation service 135 to generate an updated grammar file (280).

In another example, the changes themselves may be stored (and not just a count of events). The system 100 may analyze the changes to check which name files need to be updated for a tenant account, for example, when there are scoped name files and the changes involve those users belonging to a filtered list. For example, the system 100 can apply the filters stored associated with a name file to received change information to determine if the change belongs to a scoped name file and then create an updated name file. Once the updated name file has been created (275), the system 100 may send the updated name file along with the associated name file ID to the grammar generation service 135 to generate an updated grammar file (280). In some cases, instead of sending an entire new name file, system 100 may send the changes to the grammar generation service 135 so that the grammar generation service would then update an existing grammar based on the changes.

In yet another example, as previously mentioned, the system 100 may periodically check for changes without receiving information on changes of state from an event service. In this case, the system 100 can periodically directory states with the information in the tenant user storage resource 130 to see if there are any changes. The system 100 can then update any name file that has a change.

In addition to automatic updating of name files, the system 100 can enable “manual” updating. For example, a pull process may be carried out in response to a refresh request sent by, for example, the administrator of a tenant account or a service registered with the name file service. In some cases, the refresh request may include a request to refresh all name files associated with the tenant ID. In this case, the information may include only the tenant ID. In other cases, the refresh request may include a request to refresh a specific name file associated with the tenant ID and the filter. In one such case, the information may include the tenant ID and the filter. In response to the request to refresh, the system 100 can pull information from the tenant user resource 130 to create an updated name file.

In some cases, monitoring module 120 and name file module 125 are operated as part of separate systems. The tenant ID storage 110 and the name file ID storage 115 can be similarly separated (e.g., the system with the monitoring module 120 can include the tenant ID storage 110 and the system with the name file module 125 can include the name file ID storage 115). The system with the monitoring module 120 may then function to fetch and notify on user changes and the system with the name file module 125 may be used to act on these changes by communicating with the grammar generation service 135.

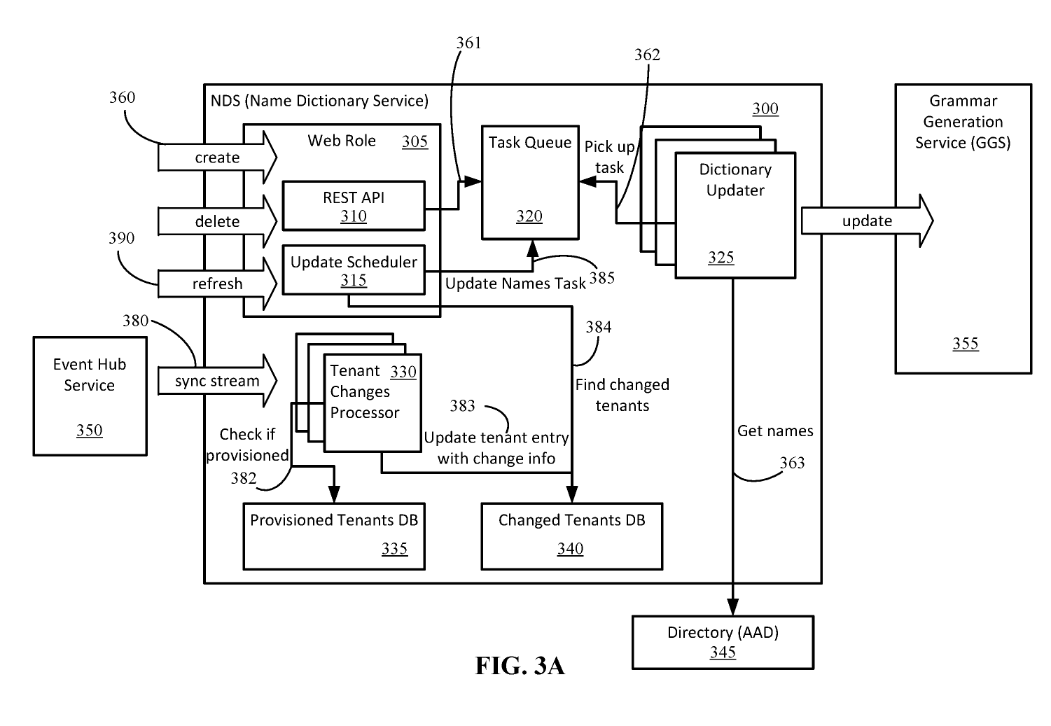

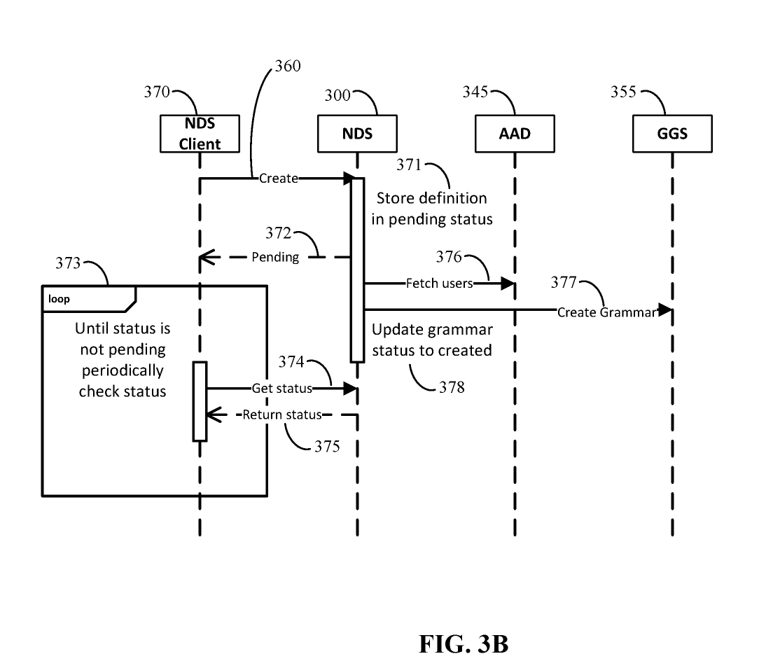

FIG. 3A illustrates an example operating environment in which an implementation of techniques for optimizing name recognition in multi-tenant systems may be practiced. Referring to FIG. 3, an example Name Dictionary Service (NDS) 300 can include a web role module 305, REST API 310, Update Scheduler 315, Task Queue 320, Dictionary Updater 325, Tenant Changes Processor 330, Provisioned Tenants database 335, and Changed Tenants database 340. The NDS 300 can run in a cloud computing platform such as Microsoft Azure®. The NDS 300 may be provided for a collaboration and communication service such as Skype® for Business. Information regarding tenants of the collaboration and communication service can be stored in a directory (AAD) 345, for example, an Azure® Active Directory. The collaboration and communication service may have an event hub service 350 that can communicate changes to tenants of the collaboration and communication service. The NDS 300 communicates with a Grammar Generation Service (GGS) 355 to generate grammar files for speech recognition.

Given a scenario where an administrator is configuring an organizational auto attendant (OAA), the administrator may first acquire a phone number, for example 1-800-MyCompany, and then provision the OAA for the tenant by registering the OAA with web role 305.

FIG. 3B illustrates a diagram with example process flows that may be implemented by the operating environment of FIG. 3A. Referring to FIGS. 3A and 3B, to register the OAA, an administrative user can execute a command (e.g., at NDS Client 370) that will call the NDS 300 through REST API 310 and include a request to provision the tenant and, at the same time or subsequently, request to create a name file for the tenant (360). In some cases, the administrative user may be presented with a user interface (UI) to initialize the OAA (and request creation of a grammar file). When an administrator registers the OAA, a tenant ID may be provided to the NDS and stored in a storage resource, such as OAA Provisioned Tenants database 335. The OAA Provisioned Tenants database 335 may include a list of all provisioned tenants. Once the administrative user provisions the tenant, the organization is known to the NDS 300.

When the administrator is provisioning the OAA (and requesting a grammar file), the NDS Client 370 may allocate a name file ID (and provide to NDS 300) or the NDS may allocate the name file ID and provide it to the NDS Client. Both of these scenarios are contemplated in the step “obtaining a new name file ID 210” as described with respect to FIG. 2A. At the NDS 300, the request to create a name file for the tenant (360) may be sent (361) to the task queue 320. The request (e.g. task item) may include the tenant ID. Once the request is in the task queue 320, a dictionary updater 325 may pick up the request (362) and create the name file. The NDS 300 can have access to the names of the employees working in the company, for example via AAD 345. The dictionary updater 325 can use the tenant ID to get (e.g., “fetch”) the names (363) of the employees associated with the tenant from the AAD 345. Then, the dictionary updater 325 can copy the names of the employees into a new name file, which the dictionary updater 325 can send to GGS 355 to generate a grammar file.

Referring to FIG. 3B, certain processes may be carried out at the time the NDS Client 370 sends the request to the NDS 300 to create the grammar file. For example, upon receipt of a create request 360, the NDS 300 validates the request sent by the NDS Client 370, stores a grammar definition with the request parameters (371), marks the definition status as pending creation, and returns the definition to the NDS client so the connection can be closed (372). The NDS client 370 can poll the NDS for the grammar status to see if the grammar is populated with the names successfully (if not, an error can be reported to the user). For example, the NDS client 370 perform a loop (373) of periodically checking status (374) based on the status returned in operation 375 by NDS 300 until status is not pending.

After returning the grammar pending response (372) to the NDS Client 370, NDS can contact AAD to fetch (376) user names according to the grammar definition parameters (stored in operation 371). This operation may be the same operation as described with respect to operation 363 of FIG. 3A. When all the names are successfully retrieved, NDS 300 can send them to GGS 355 to create the actual grammar file (377). In some cases, batches of users are retrieved from AAD 345 and sent to GGS 355 in a stream or small chunks, instead of a bulk operation. The NDS 300 can update the grammar status to created 378 and return the updated status in operation 375 to inform the NDS client 370 that the status is no longer pending.

The GGS 355 can internally generate the grammar file and generate a unique grammar file ID for the grammar file (associated with the name file ID), which can be communicated to the OAA and/or speech recognition service. Thus, when a telephone call to the OAA is received, the OAA can communicate a grammar ID associated with the grammar file that was generated for the OAA by the NDS to a speech recognition service together with audio data the caller may provide when they say the name. By using a current grammar file (facilitated through the NDS 300), the speech recognition service can perform an optimized speech recognition.

Returning to FIG. 3A, after the OAA is registered and the name file created, the NDS 300 can monitor any name change that occurs and create an updated name file to send to the GGS 355. The information on changes to a tenant may be received from event hub service 350. The event hub service 350 can sync the information received on changes to the tenant to produce a sync stream 381 and the NDS 300 can receive the sync stream 381, via the tenants changes processor 320. The tenants change processor 320 can process the sync stream 381 by filtering the information in the sync stream based on, for example, the tenant ID (e.g., checking if tenant is provisioned (382) by checking the Provisioned Tenants DB 335), and update the tenant entry with the change information (383) by storing the information in a changed tenants DB 340. The tenants change processor 330 may perform multiple processes at the same time.

Once the changed tenants DB 340 has reached a certain level of changes (e.g. a threshold), the grammar file may be updated. However, in some cases, the NDS 300 may not receive an update. In this case, the NDS 300 may pull the updates itself. The NDS 300 can fetch (363) all users of a tenant and refresh the associated grammar file. The NDS 300 may pull the data in the case of a failure or if the NDS 300 is not certain that the last name file is up to date.

For example, to perform a pull operation update of the grammar file—or in response to receiving a refresh request (390), an update scheduler 315 can find the changed tenants (384) in the changed tenants DB 340. Then, the update scheduler 315 can send an update name task (385) to the task queue 320 for the dictionary updater 325 to pick up. The dictionary updater 325 can pick up the update name task (362) from the task queue 320 and execute the task. The task may include information (e.g., the tenant ID and any other filters) that allows the dictionary updater 325 to execute the task. The dictionary updater 325 can get all the names associated with the tenant ID and any other information from the AAD 345 and create an updated name file. The dictionary updater 325 can then send the updated name file and name file ID to the GGS 355 to generate an updated grammar file.

As described above, cloud and name optimized speech recognition is possible through incorporation of the described name file service. The name file service can operate in conjunction with any cloud-based multi-tenant service architecture.

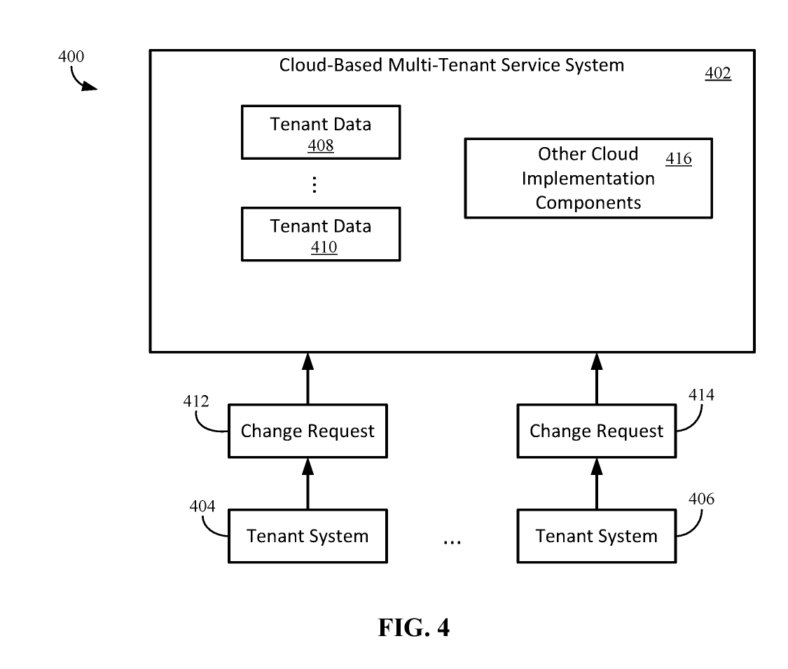

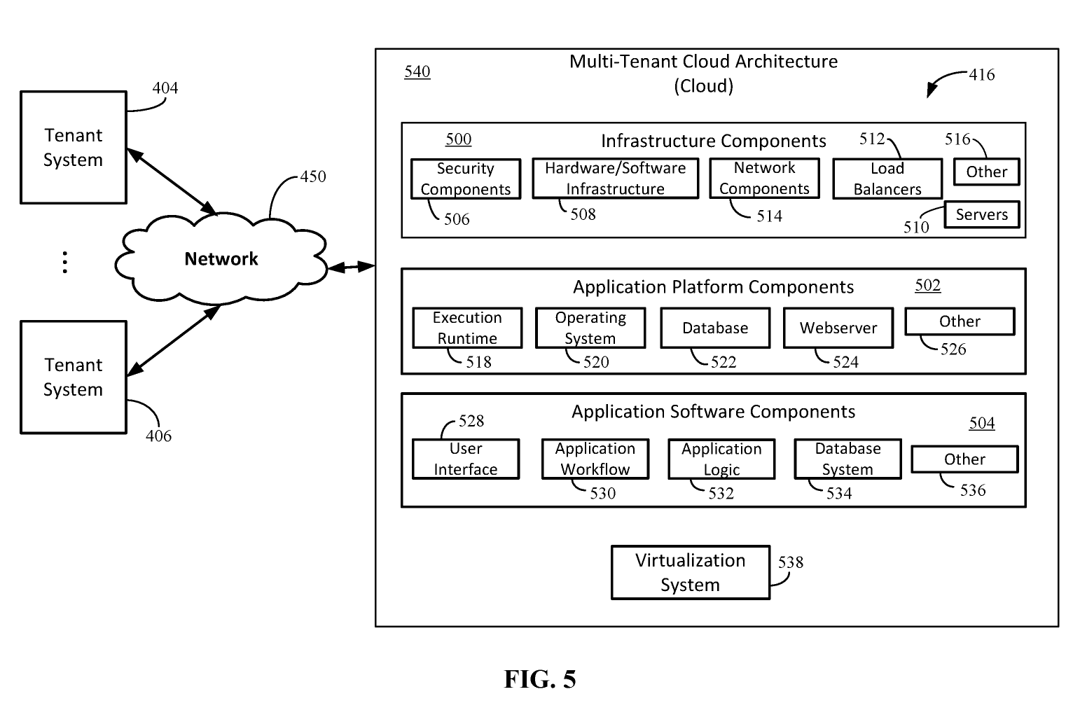

FIG. 4 illustrates a block diagram of one example of a cloud-based multi-tenant service architecture; and FIG. 5 is a block diagram illustrating different levels of multi-tenancy in one example of a multi-tenant cloud architecture.

Referring to FIG. 4, architecture 400 includes a cloud-based multi-tenant service system 402 that is accessible by a plurality of different tenant systems 404, 406.

Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

As is described in greater detail below with respect to FIG. 5, multi-tenant services can be provided at the infrastructure level, at the application platform level, or at the application software level, among others. Thus, depending on the particular level of multi-tenancy that is provided by system 402, the information corresponding to a particular client (or tenant) will be separated at that level, and isolated so it cannot be accessed by other clients (or tenants).

By way of example, if system 402 provides infrastructure as a service, then the infrastructure components of system 402 are shared by tenants 404, 406, but their information is otherwise kept separate. If system 402 provides a platform as a service, then the platform components are shared by tenants 404, 406. If system 402 provides application software as a service, then a common application is run by system 402 to service tenants 404, 406. In any of these implementations, because system 402 provides some level of multi-tenancy, the information corresponding to the different tenants 404, 406 is kept separate. This is described in greater detail below with respect to FIG. 5.

In the example of system 402, shown in FIG. 4, tenant systems 404, 406 access applications that operate on their corresponding tenant data 408, 410. Tenant system 404, 406 may provide change requests 412, 414 to change their corresponding tenant data 408, 410. By way of example, tenant 404 may be migrating a number of users from an on-premise system to the cloud-based system 402. Therefore, the change requests 412 may be to add one or more e-mail accounts in the on-premise system 402 for tenant system 404. In another example, tenant system 406 may have acquired another organization and therefore may need to add one or more electronic mail accounts to its cloud-based implementation in system 402. In yet another example, the organization that uses tenant system 404 may have reorganized. Therefore, it may need to change one or more employee records to show that they are no longer part of the human resources department, but are now part of the marketing department. In any of these examples, or a wide variety of other examples, the changes to the cloud-based implementation for the tenants may be relatively small in number to relatively large in number. When these changes occur, the cloud-based system 402 may include processes that keep track of the changes and provide event change information such as described with respect to service 140 of FIG. 1B.

FIG. 5 is a block diagram showing a more detailed example of a multi-tenant cloud architecture 540 in which system 402 can be implemented. FIG. 5 shows one example of the other cloud implementation components 416 (shown in FIG. 4) in more detail.

Referring to FIG. 5, components 416 in system 402 illustratively include virtualization system 538, infrastructure components 500, application platform components 502, and application software components 504. Infrastructure components 500 can include security components 506, hardware/software infrastructure 508, servers 510, load balancing components 512, network components 514, as well as other components 516.

Application platform components 502 can include execution runtime components 518, operating system components 520, database components 522, web server components 524, as well as other components 526. Application software components 504 illustratively include user interface components 528, application workflows 530, application logic 532, database systems 534, as well as other items 536.

Depending on the level of multi-tenancy implemented by cloud 540, virtualization system 538 will electronically separate the physical computing device components 416 into one or more virtual devices. Each of these devices can be used and managed to perform computing tasks.

Multi-tenant cloud computing architecture 540 can provide services at a number of different levels, according to a number of different models. They can include, for instance, infrastructure as a service (IaaS), platform as a service (PaaS) and software as a service (SaaS), among others. IaaS is the most basic and each of the higher level models (PaaS and SaaS, respectively) abstract from the details of the lower models.

In IaaS, physical or virtual machines are provided, along with other resources. A supervisory component (sometimes referred to as a hypervisor) runs the virtual machines. Multiple different hypervisors can be used to run a relatively large number of virtual machines and to scale up and down according to the needs of various tenants. The IaaS model can also offer additional resources (such as other infrastructure components 516) on-demand. In order for a tenant to deploy their applications, they install operating system images as well as their application software on the cloud infrastructure components 500. The tenant is then responsible for maintaining the operating systems and application software.

PaaS involves the cloud architecture 540 providing the application platform components 502 as a service. Application developers can develop and run their software on the application platform components 502 without needing to manage the underlying hardware and software layers.

SaaS involves architecture 540 providing access to application software and databases in application software components 504. The cloud architecture 540 manages the infrastructure components 500 and the application platform components 502 that run the applications. The cloud 540 also installs and operates the application software in application software components 504 and tenants access the software but do not manage the cloud infrastructure components 500 or application platform components 502 where the application runs. In such an implementation, virtualization system 538 provides multiple virtual machines at runtime to meet changing workloads. Load balancers distribute the work over the virtual machines. This process is often transparent to the tenant who sees only a single access point to the application.

In a multi-tenant environment, any machine can serve more than one user organization that deploys a tenant system 404, 406. Multi-tenancy, however, can apply to all three layers of cloud architecture (IaaS, PaaS and SaaS). The exact degree of multi-tenancy may be based on how much of the core application (or application components 504) is designed to be shared across tenants 404, 406. A relatively high degree of multi-tenancy allows the database schema to be shared and supports customization of the business logic, workflow and user interface layers. In a relatively low degree of multi-tenancy, the IaaS and PaaS components 500 and 502, respectively, may be shared by the application components 504 that have dedicated virtualized components that are dedicated to each tenant.

The discussion above has proceeded with respect to the cloud-based multi-tenant service system 402 offering software as a service. Therefore, the virtualization system 538 will provide separate virtual machines to provide each tenant 404, 406 with their own, secure and separate virtual computing environment on the application software level. Thus, each tenant 404, 406 can make changes to their own application (such as their own electronic mail application, document management system, business system, etc.).

It is also contemplated that some elements of system 402 can be disposed in the cloud while others are not. By way of example, the databases and data stores can be disposed outside of cloud 540, and accessed through cloud 540. In another example, other components can be outside of cloud 540. Regardless of where they are located, they can be accessed directly by devices in tenant systems 404, 406, through a network 550 (e.g., a wide area network or a local area network), they can be hosted at a remote site by a service, or they can be provided as a service through a cloud or accessed by a connection service that resides in the cloud. All of these architectures are contemplated herein.

It will also be noted that architecture 400, or portions of thereof, can be disposed on a wide variety of different devices, including system 600 on which the described name file service may be embodied. Some of those devices on which architecture 400, or portions thereof, can be disposed include servers, desktop computers, laptop computers, tablet computers, or other mobile devices, such as palm top computers, cell phones, smart phones, multimedia players, personal digital assistants, etc.

FIG. 6 illustrates components of a computing system that may be used to implement certain methods and services described herein. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices and appliances. The system hardware can be configured according to any suitable computer architectures such as a Symmetric Multi-Processing (SMP) architecture or a Non-Uniform Memory Access (NUMA) architecture.

The system 600 can include a processing system 620, which may include one or more processors and/or other circuitry that retrieves and executes software 605 from storage system 615. Processing system 620 may be implemented within a single processing device but may also be distributed across multiple processing devices or sub-systems that cooperate in executing program instructions.

Examples of processing system 620 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system(s) 615 can include any computer readable storage media readable by processing system 620 and capable of storing software 605 including instructions for name file service 610. Storage system 615 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a transitory propagated signal.

Storage system 615 may be implemented as a single storage device but may also be implemented across multiple storage devices or sub-systems co-located or distributed relative to each other. Storage system 615 may include additional elements, such as a controller, capable of communicating with processing system 620.

In some cases, storage system 615 includes a storage resource (not shown) for name file IDs and/or tenant IDs (e.g., name file ID storage 115 and tenant ID storage 110). In other cases, the data resources are part of a separate system with which system 600 communicates, such as a remote storage provider. For example, data, such as a plurality of tenant identifiers may be stored on any number of remote storage platforms that may be accessed by the system 600 over communication networks via the communications interface 625. Such remote storage providers might include, for example, a server computer in a distributed computing network, such as the Internet. They may also include “cloud storage providers” whose data and functionality are accessible to applications through OS functions or APIs.

Software 605 may be implemented in program instructions and among other functions may, when executed by system 600 in general or processing system 620 in particular, direct the system 600 or processing system 620 to operate as described herein for a name file service 610.

Software 605 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 6, can be thought of as additional, nested groupings within the operating system space, each containing an OS, application programs, and APIs.

Software 605 may also include firmware or some other form of machine-readable processing instructions executable by processing system 620.

System 600 may represent any computing system on which software 605 may be staged and from where software 605 may be distributed, transported, downloaded, or otherwise provided to yet another computing system for deployment and execution, or yet additional distribution.

A communication interface 625 may be included, providing communication connections and devices that allow for communication between system 600 and other computing systems (not shown) over a communication network or collection of networks (not shown) or the air. In embodiments where the system 600 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

Certain techniques set forth herein with respect to the described name file service may be described in the general context of computer-executable instructions, such as program modules, executed by one or more computing devices including holographic enabled devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

By way of example, and not limitation, computer-readable storage media may include volatile and non-volatile memory, removable and non-removable media implemented in any method or technology for storage of information such as computer-readable instructions, data structures, program modules or other data. Examples of computer-readable storage media include volatile memory such as random access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the term “storage media” consist of transitory propagating signals.

It should be understood that the examples and embodiments described herein are for illustrative purposes only and that various modifications or changes in light thereof will be suggested to persons skilled in the art

1. A computer-implemented method for optimizing name recognition in multi-tenant systems comprising:
in response to receiving a request to create a new name file for generating a grammar file:
obtaining a new name file identifier for the new name file;
creating the new name file by populating the new name file with user names associated with the request;
sending the new name file to a grammar generation service to generate the grammar file, the grammar file being identified by the new name file identifier; and
storing the new name file identifier and a grammar file identifier in a storage resource, the storage resource storing at least the new name file identifier;

2. The method of claim 1, wherein the request to create the new name file comprises one or more filter parameters for identifying the user names associated with the request.

3. The method of claim 2, wherein the one or more filter parameters comprises a tenant identifier that identifies a tenant account comprising a plurality of users associated therewith.

4. The method of claim 3, wherein populating the new name file with user names associated with the tenant account comprises:
accessing a tenant user storage resource for a list of user names associated with the tenant account, the tenant user storage resource including user names associated with the tenant account identified by the tenant identifier.

5. The method of claim 3, wherein the one or more filter parameters further comprises at least one of a user position, a department, and a geographical location of users.

6. The method of claim 1, wherein the request to create the new name file comprises a tenant identifier that identifies a tenant account comprising a plurality of users associated therewith, the method further comprising:
monitoring for changes to users associated with the tenant account; and
based on changes to the users associated with the tenant account, creating an updated name file associated with the new name file identifier and sending the updated name file to the grammar generation service to generate an updated grammar file, the new name file identifier now referencing the updated grammar file.

7. The method of claim 6, wherein the changes comprise one or more of an addition, modification, or removal of property of a user associated with the tenant account.

8. A system comprising:
a processing system;
a storage system comprising a storage resource; and
instructions for optimizing name recognition in multi-tenant systems stored on the storage system that when executed by the processing system, direct the processing system to at least:
in response to receiving a request to create a new name file for generating a grammar file:
obtain a new name file identifier for the new name file, wherein the request to create the new name file comprises one or more filter parameters for identifying user names associated with the request;
populate the new name file with the user names associated with the request and based on the one or more filters; and
send the new name file to a grammar generation service to generate the grammar file, the grammar file being identified by the new name file identifier.

9. The system of claim 8, wherein the one or more filter parameters comprises a tenant identifier that identifies a tenant account comprising a plurality of users associated therewith.

10. The system of claim 9, wherein the instructions that direct the processing system to populate the new name file with user names direct the processing system to at least:
access a tenant user storage resource for a list of user names associated with the tenant account, the tenant user storage resource including user names associated with the tenant account identified by the tenant identifier.

11. The system of claim 9, wherein the instructions for optimizing name recognition in multi-tenant systems further comprise instructions that direct the processing system to:
monitor for changes to users associated with the tenant account; and
based on changes to the users associated with the tenant user account, create an updated name file associated with the new name file identifier and send the updated name file to the grammar generation service to generate an updated grammar file, the new name file identifier now referencing the updated grammar file.

12. The system of claim 8, wherein the one or more filter parameters comprises at least one user property.

13. The system of claim 8, wherein the one or more filter parameters comprises at least one or more user names.

14. The system of claim 11, wherein the instructions that direct the processing system to populate the new name file direct the processing system to at least:
access a storage resource for a list of user names that satisfy the one or more filter parameters.

15. One or more computer readable storage media having instructions stored thereon that when executed by a processing system, direct the processing system to at least:
in response to receiving a request to create a new name file for generating a grammar file:
create a new name file identifier for the new name file, wherein the request to create the new name file comprises one or more filter parameters, the one or more filter parameters comprising a tenant identifier that identifies a tenant account comprising a plurality of users associated therewith;
populate the new name file with user names associated with the tenant account;
send the new name file to a grammar generation service to generate the grammar file, the grammar file being identified by the new name file identifier; and
store the new name file identifier in a storage resource, the storage resource storing at least the new name file identifier and the tenant identifier associated with the new name file;
monitor for changes to users associated with the tenant account; and
based on changes to the users associated with the tenant user account, create an updated name file associated with the new name file identifier and send the updated name file to the grammar generation service to generate an updated grammar file, the new name file identifier now referencing the updated grammar file.

16. The media of claim 15, wherein the instructions that direct the processing system to populate the new name file with user names associated with the tenant account direct the processing system to at least:
access a tenant user storage resource for a list of user names associated with the tenant account, the tenant user storage resource including user names associated with the tenant account identified by the tenant identifier.

17. The media of claim 15, wherein the one or more filter parameters further comprise at least one of a user position, a department, and a geographical location of users.

18. The media of claim 17, wherein the instructions that direct the processing system to populate the new name file with user names associated with the tenant account direct the processing system to at least:
access a tenant user storage resource for a list of user names associated with the tenant account that satisfy the one or more filter parameters.

19. The media of claim 15, further comprising instructions that direct the processing system to:
in response to receiving a request to delete a name file, the request comprising a specified tenant user identifier:
send an indication to the grammar generation service to delete a particular grammar file; and
remove the name file identifier from the storage resource.

20. The media of claim 15, wherein the instructions that direct the processing system to monitor for changes to users associated with the tenant account direct the processing system to at least:
receive information on changes of state of tenants;
identify, from the information on changes of state of tenants, the changes of state of the tenant corresponding to the tenant ID; and
update a tenant entry to indicate that there are changes to users associated with the tenant account,
wherein the media further comprises instructions that direct the processing system to:
check the tenant entry to determine whether the updated name file should be created.
